(19) United States
(12) Patent Application Publication
(10) Pub. No.: US 2011/0103758 A1
(43) Pub. Date: May 5, 2011

(54) OPTICAL FIBER AND METHOD OF MANUFACTURING THE SAME

(75) Inventors: Kazumasa OHSONO, Hitachi (JP); Bing YAO, Hitachi (JP); Tomomi ONOSE, Tokai (JP)

(73) Assignee: Hitachi Cable, Ltd.

(21) Appl. No.: 12/915,586

(22) Filed: Oct. 29, 2010

(30) Foreign Application Priority Data
Oct. 30, 2009 (JP) 2009-250018

(51) Int. Cl. G02B 6/032; C03B 37/012; C03B 37/02; G02B 6/028

(52) U.S. Cl. 385/124; 65/399; 385/125

(57) ABSTRACT

An optical fiber comprising: a core formed in a center axis area; an inner clad layer, disposed around the core, having a refractive index smaller than that of the core; a pore layer, disposed around the inner clad layer, having a plurality of elongated pores; and an outer clad layer, disposed around the pore layer, having a refractive index equal to or smaller than the refractive index of the core, wherein a length of the elongated pores is not larger than 200 m.

### CLAIM OF PRIORITY

The present application claims priority from Japanese Patent Application Serial No. 2009-250018, filed on Oct. 30, 2009, the content of which is hereby incorporated by reference into this application.

### FIELD OF THE INVENTION

The present invention relates to an optical fiber whose non-linear phenomenon is suppressed, and more particularly to an optical fiber suitable for a submarine optical cable.

### BACKGROUND OF THE INVENTION

In recent years, with a rapid progress of the Internet enlargement of capacity of transmission media for transmitting information has been carried out. Among technologies for enlarging the transmission capacity, there is a wavelength multiplexing transmission system (WDM). If the capacity of the WDM transmission system is enlarged, the possibility of occurrence of non-linear effect phenomenon that invites deterioration of transmission characteristics of the optical fiber will become high. Accordingly, in recent years, development of optical fiber for suppressing the occurrence of the non-linear phenomenon has been conducted out, which is essential for the enlargement of the transmission capacity. In addition, in order to improve the transmission characteristics, reduction in an optical signal loss due to bending of the fiber is necessary. Therefore, optical fibers with a large effective cross sectional area and a small bending loss have been developed. Optical fibers for attaining the above objects are disclosed in patent document Nos. 1 and 2, wherein the bending loss is made small in such a manner that an outer diameter of a core is made large so as to make the effective cross sectional area large and bubbles or voids that penetrate throughout the entire length of the fiber are formed so that a difference in refractive indexes between the core portion and a clad layer surrounding the core portion is formed.

Information network of the internet etc covers the whole world. Therefore, introduction of the WDM transmission system into long distance large capacity transmission routes for connecting continents such as submarine optical cable systems is being carried out. However, as disclosed in patent document No. 1, if the optical fiber having bubbles extending over the entire length is used as the submarine optical fiber, sea water may enter the pores by the action of capillary action from a broken point of the fiber when the optical fiber is broken. The pores where the sea water entered give adverse affect to the transmission characteristics of the fiber. Especially, the submarine optical fibers may be laid sometimes on the bottom of the see as deep as 8000 m or so. In such case, the permeation of sea water into the pores is caused not only by the capillary action, but also by the hydraulic pressure so that a permeation length of the sea water becomes great in some cases.

Since it is impossible to remove the sea water entered the pores as a matter of practice, replacement of the broken portion of the fiber is necessary, and the whole optical fiber should be replaced. Therefore, development of such optical fibers that a length of replacement is as short as possible has been demanded, even if the submarine optical fiber is broken.

The optical fiber disclosed in patent document Nos. 2, 4-7 has bubbles, which are formed in the clad layer. Therefore, even if the optical fiber is broken on the bottom of the sea, a permeation length of the sea water is limited to the certain extent, though there is permeation of sea water. As a result, it is possible to limit a length of replacement of the optical fiber.

The optical fiber disclosed in patent document No. 3 has cylindrical pores inside of the fiber along the longitudinal direction thereof, where partition walls are formed at both ends of the pores or along the longitudinal direction of the pores. If the optical fiber is broken on the bottom of the sea, permeation of sea water is stopped by the partition walls to some extent, though there is permeation of sea water. As a result, it is possible to shorten the length of replacement of the fiber where the sea water permeated, and it is possible to reduce the cost of replacement.
Patent document No. 1: Japanese patent laid-open 2004-226540
Patent document No. 2: Japanese patent laid-open 2009-69238
Patent document No. 3: Japanese patent laid-open 2003-202431
Patent document No. 4: U.S. Pat. No. 7,526,166
Patent document No. 5: U.S. Pat. No. 7,450,806
Patent document No. 6: Japanese patent laid-open 2004-20836
Patent document No. 7: WO 2007/05881
Non-patent document No. 1: “Optical Submarine Cable Communications” pp. 78-79, Dec. 20, 1991, KDD Engineering and Consulting (KEC)

However, the optical fiber disclosed in patent document Nos. 2, 4-7 does not touch the length of the bubbles, though the permeation of sea water is stopped to some extent. That is, if a size of the bubbles is large before drawing the preform of the optical fiber, the length of the bubbles may become quite long. In such case, if the optical fiber is used as submarine cables, the length of sea water permeation becomes long. As a result, reduction in a cost of replacement of the broken fiber is insufficient.

The optical fiber disclosed in patent document No. 3 may stop the permeation of sea water by the partition walls to some extent, but bending loss of optical signals is quite large because the partition walls do not have pores. In more detail, when the optical fiber is bent, the optical signal may leak from the partition walls if they are positioned just at the bending points of the fiber so that a loss of the optical signals become large.

### SUMMARY OF THE INVENTION

The present invention was made in considering the above problems, and an object of the present invention is to provide an optical fiber, which has improved transmission characteristics and a broken portion of which is capable of being replaced at a low cost, and to provide a method of manufacturing the optical fiber.

The present invention was made under the circumstances mentioned above. The present invention is to provide an optical fiber comprising a core disposed in the center axis region, an inner clad layer disposed outside of the core, a refractive index of the inner clad layer being smaller than that of the core, a pore layer having a plurality of elongated pores, disposed around of the inner clad layer, and an outer clad layer disposed around of the pore layer, a refractive index of the outer clad layer being the same or smaller than that of the core, wherein a length of the elongated pores is 200 m or less. A preferable length of the elongated pores is 10 to 200 m. The pore layer may have elongated pores having an outer diameter of 1 μm or less in a cross section in an axial direction of the pore layer.

An effective cross section of the core with respect to a wavelength of light transmitting through the core should preferably be 80 m² or more. Especially, a more preferable effective cross section is 80 to 200 μm².

At least a part of the pore layer should preferably be located within a circle having a radius from the center axis, and the circle has a radius of a mode field diameter in a wavelength of light transmitting through the core.

The present invention relates to a method of manufacturing an optical fiber comprising:

a step of forming a preform of an inner clad layer outside of a preform of a core;

a step of forming a pore layer around the preform of the inner clad layer;

a step of forming a preform of an optical fiber by unitedly shaping the preform of the core and the preform of the pore layer; and

a step of drawing the preform of the optical fiber; wherein the preform of the pore layer is prepared by heating a material similar to the preform of the inner clad layer in an atmosphere of a mixed gas of He gas and N₂ gas to thereby forming pores of N₂ having an outer diameter of 1.2 mm or less.

The preform of the pore layer may be prepared by heating in the mixed gas atmosphere of He and N₂=(90 to 30%: (10% to 70%) by volume.

According to the present invention, it is possible to provide an optical fiber with improved transmission characteristics of light signals and with a low cost for replacement of the broken fiber into which sea water permeates, and to provide a method of manufacturing the optical fiber.

### BRIEF DESCRIPTION OF THE DRAWINGS

FIG. 1 is a cross sectional view of an optical fiber along the center axis thereof according to a preferred embodiment of the present invention.

FIG. 2 is a perspective view of the optical fiber according to the preferred embodiment.

FIG. 3 is a diagrammatic view of an electric furnace 21 used for heating treatment in a method of manufacturing an optical fiber of a preferred embodiment.

FIG. 4 is a photograph of a cross section in a direction of the center axis of an optical fiber 1 according to a preferred embodiment.

### DETAILED DESCRIPTION OF PREFERRED EMBODIMENTS

Descriptions of the patent documents and the non-patent document listed constitute parts of the description of the present specification as long as the descriptions of the documents are useful for understanding the present invention.

The preferred embodiment of the present invention will be explained by reference to drawings.

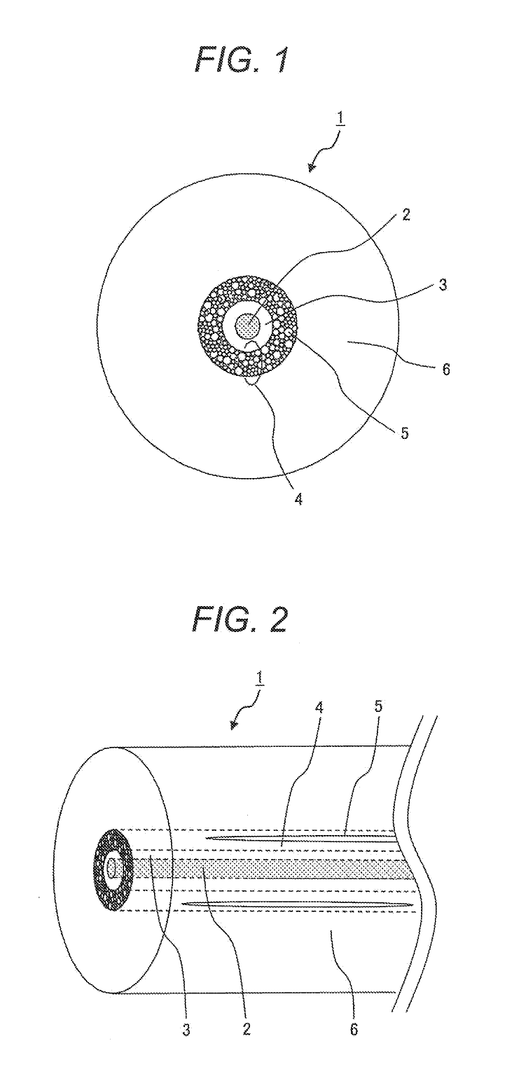

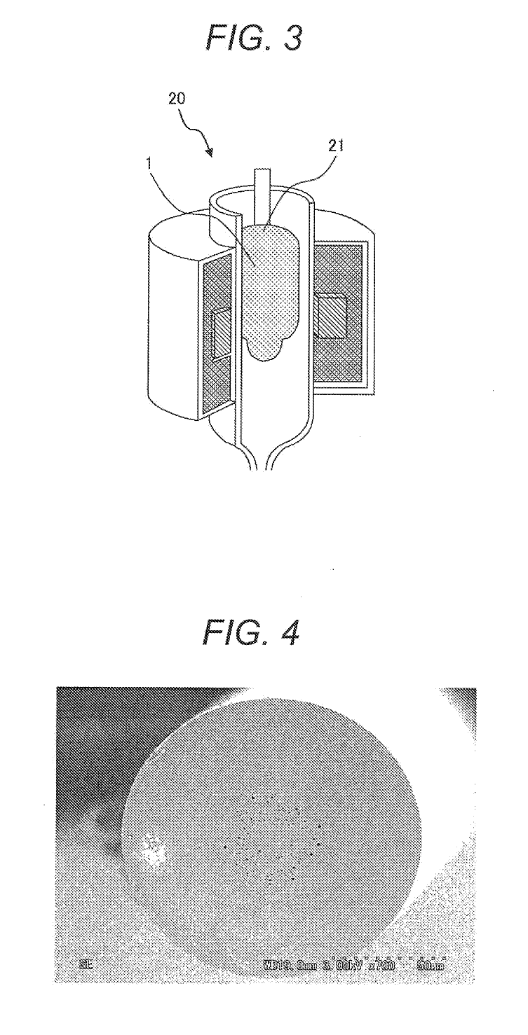

FIG. 1 is a cross sectional view along the center axis of the optical fiber according to the preferred embodiment of the present invention. FIG. 2 is a side sectional view of the optical fiber of the preferred embodiment of the present invention.

The preferred embodiment of the present invention relates to the optical fiber for an optical submarine cable 1, which comprises a core 2 disposed at the center axis region, an inner clad layer 3, disposed around the core 2, having a refractive index smaller than that of the core, a pore layer 4, disposed around the inner clad layer 4, having a plurality of elongated pores 5 and an outer clad layer 6, disposed around the pore layer, having a refractive index similar to or smaller than the refractive index of the core 2, wherein a length of the elongated pores in a longitudinal direction of the optical fiber is 200 m or less.

In more detail, the optical fiber has the following features. As shown in FIG. 1, the pore layer 4 is formed to surround the inner clad layer 3, which is formed around the core 2. The reason why the pore layer 4 having elongated pores in a concentric relation is disposed by means of the inner clad layer 3 with a distance from the core layer 2 is that: There may be a problem that when the pore layer 2 is disposed at a position close to the core 2, the pores 5 may foam at the position close to the core during the step of forming the pores 5 in the pore layer 4 so that the outer shape of the core 2 may be deformed. For that reason, in order to avoid deterioration of the transmission characteristics of the optical fiber 1, the pore layer 4 is formed with distance from the core 2.

In addition, the outer clad layer 6 is formed around the pore layer 4. An outer diameter of the optical fiber 1 was 125 μm. The elongated pores 5 is formed to reduce the bending loss, which occur when the optical fiber is bent. The pores 5 are not perforated in the longitudinal direction of the optical fiber in order to reduce the permeation length of sea water in the optical fiber 1 at the time of breakage of the optical fiber, which is installed on the bottom of the sea, as shown in FIG. 2. The length of the pore is 200 m or less.

The reason why the length of the pore is 200 m or less is explained by reference to non-patent document No. 1 as follows. The non-patent document No. 1 describes a relationship between water running time and water running distance at the time of breakage of an optical submarine cable which is laid on the bottoms of the sea of 1000 m and 5500 m. The length of 1000 m corresponds to shallow sea, and the length of 5500 m corresponds to a deep sea on the bottom of the sea. As is described in the non-patent document No. 1, the water running time and the water running distances of the submarine cable at the time of cable breakage is about 2 weeks and about 200 m and about 1000 m, respectively.

As a matter of course, the submarine optical cables are laid on the bottoms of shallow sea area to deep sea area. Therefore, if the length of the pores 5 in the longitudinal direction of the optical fiber is set to 1000 m in accordance with the water running distance in 5500 m, a replacement length of the broken portion of the submarine optical cable becomes very long because the length of the pores 5 is 1000 m, while the water running distance is only about 200 m in the shallow sea of a depth of about 1000 m. As a result, a cost for replacement of the broken submarine cable increases. Thus, if the length of the pores 5 is set to 200 m or less in accordance with the water running distance in the shallow sea, the replacement length can be limited to the minimum and the cost for the replacement can be reduced.

The length of the pore 5 should preferably be 10 to 200 m, which is decided by a size of the pore before drawing or by performance of a drawing machine. In this embodiment, the length of the pore was set to about 100 m in order to further reduce the permeation length of sea water at the time of breakage of the optical fiber. In addition, at least a part of the pores 5 should have an outer diameter of not larger than 1 μm at a given cross section of the optical fiber. This means that the plurality of pores 5 constituting the pore layer 4 should have a given outer diameter at the given cross section of the optical fiber. That is, it is not necessary that the shape of the pores 5 should not be the same.

The core 2 is made of quartz. An additive for increasing refractive index of the core material was added throughout the core 2. As the additive for increasing the refractive index, germanium oxide was added to the quartz. The additive may be Ti or rare earth elements such as Er.

An outer diameter of the core 2 is determined by a combination of a desired effective cross section (hereinafter referred to as Aeff), a cut-off wavelength, which makes a single mode transmission possible, and a difference in the refractive indexes (Δn) between the refractive index of the core 2 and the refractive index of the inner clad layer 3. At present, Aeff at the wavelength of 1.3 μm of the single mode fiber (SMF) of 1.3 μm band, which is the most widely used, is about 60 μm². However, with an increase in transmission capacity, when the signal light intensity increases, the transmission loss increases by virtue of non-linear effect phenomenon. In order to reduce the non-linear effect phenomenon, an increase in Aeff of the core 2 in a wavelength of the light transmitting through the core 2 is effective. Therefore, Aeff should preferably be 80 μm² or more so as to suppress the non-linear effect phenomenon that brings about the transmission loss of the optical fiber 1.

In order to solve a problem that to set the cutoff wavelength to be 1.26 μm or less is difficult, which is necessary to transmit 1.3 μm band, Aeff of the core 2 in the wavelength of light transmitting through the core 2 should preferably be set to be 80 to 200 μm². In this embodiment, Aeff was set to 170 μm². In order to make Aeff=170 μm², germanium oxide was added to the entire of the core in a predetermined amount so that the refractive index difference (Δn) was set to 0.18% and that the outer diameter of the core 2 was set to 15 μm. In this case, the mode field diameter (MFD) of the optical fiber 1 was 15.3 μm when the wavelength of light transmitting through the core 2 was 1.55 μm.

The pore layer 4 should preferably be located between the center axis thereof and a circle, which has a radius of the mode field diameter in a wavelength of light transmitting through the core 2. That is, the pore layer 4 should be located inside the circle. In this embodiment, in order to transmit the light having a wavelength of 1.55 μm through the core 2 of the optical fiber 1, the pore layer 4 should preferably be at a position from the center axis and within a circle of a radius of 15.3 μm. By doing so, it is possible to further reduce the bending loss and to improve stress resistance of the optical fiber.

In addition, it is possible to improve the stress resistance when a part of the pores layer 4 is located within a circle having a radius of 15.3 μm from the center axis thereby to reduce the bending loss. That is, a distance L1 between the innermost peripheral face of the pore layer 4 (a boundary face between the inner clad layer 3 and the pore layer 4) and the center axis is made smaller than the mode field diameter R in the wavelength of light transmitting through the core 2 (L1<R), and a distance L2 (L1<L2) between the outermost peripheral face of the pore layer 4 (a boundary face between the pore layer 4 and the outer clad layer 6) and the center axis is set to be a given value (any one of L2=R, L2<R and L2>R).

Next, a method of manufacturing the optical fiber of this embodiment will be explained by reference to drawings. The method relates to manufacturing of the optical fiber 1 of this embodiment which has at least one pore 5 having an outer diameter of not larger than 1 μm in a given cross section of the optical fiber 1 and a length of the pores 5 is 100 m or less.

The method of manufacturing the optical fiber comprises a step of forming an inner clad preform around a core preform, a step of forming a pore layer preform around the inner clad layer preform, a step of forming an optical fiber preform around the pore layer that unifies the core preform, the inner clad layer preform and the pore layer preform by an outer clad layer preform, a step of drawing the unified optical fiber preform, wherein the pore layer preform, which is almost the same material as the inner clad material is heated in a mixed gas of He gas and N₂ gas to form gas bubbles having a diameter of 1.2 mm or less in the pore layer preform.

In the following, the detail of the method will be explained. The first step will be explained. The step 1 is to prepare the core soot preform comprising the core 2 and a part of the inner clad layer 3 by a VAD (Vapor phase Axial Deposition) method. An outer diameter of the resulting core soot preform was 80 mm and an outer diameter of the core was 40 mm. A length of the core soot preform was 800 mm.

Next, the step 2 will be explained. The step 2 is a process for preparing transparent glass material by heat treating the core soot preform 10 while He gas and Cl₂ gas were being supplied to the core soot preform. The core soot preform was heat treated in an electric furnace 20 at a temperature of 1600° C. The electric furnace was equipped with a quartz muffle 21, which is separated from atmosphere. The quartz muffle 21 is supplied with He gas, Cl₂ gas and N₂ gas.

The heat treatment at the step 2 was carried out by supplying 20 l/min. of He gas, 0.5 l/min. of Cl₂ gas and N₂ gas to the quartz muffle 21. He gas was used to make easily the core soot material to a transparent glass material because He gas has a large diffusion coefficient. N₂ gas was used to remove OH radicals remaining in the core soot preform thereby to improve transmission characteristics of the optical fiber 1. The resulting transparent glass preform had an outer diameter of 40 mm, an outer diameter of the core was 20 mm, and a length was 500 mm.

The step 3 will be explained. The step 3 is to prepare a core material by drawing the transparent glass material. An outer diameter of the core material was 30 mm and a length thereof was 700 mm.

The step 4 will be explained. The step 4 is to prepare an outer clad soot preform, which is a part of the inner clad layer 3 and is a deposition layer corresponding to the pore payer 4 around the core material by an OVD (Outside Vapor Deposition) method.

Next, the step 5 will be explained. The step 5 is to prepare a glassification preform by heat treating the outer clad soot preform while supplying He gas and N₂ gas to the outer clad soot preform. The outer clad soot preform was heat treated in an electric furnace at 1600° C. The reason why the heat treating was carried out under supplying He gas and N₂ gas is explained. N₂ gas has a smaller diffusion coefficient than He. Therefore, N₂ gas bubbles easily remain in the glassification preform. The remaining N₂ gas bubbles are elongated during the drawing step to form independent pores 5 having a diameter of not larger than 1 μm so that elongated pores 5 having a length of not longer than 100 m in the pore layer 4 are formed.

However, if only N₂ gas is supplied, outer diameters of the remaining N₂ gas bubbles become too large. As a result, an occurrence frequency of elongated pores 5 having the outer diameter larger than 1 μm becomes high and elongated pores having a length larger than 100 m are formed. A supplying ratio of He gas to N₂ gas should preferably be He:N₂=(90 to 30%): (10 to 70%) by volume. In the above range of the supplying ratio, the length of the pores 5 does not exceed 100 m when the fiber preform is subjected to drawing. In this embodiment, the ratio of He to N₂ was 50% to 50%, and a supply amount was 10 l/min. The resulting glassification preform had an outer diameter of 40 mm and a length was 700 mm.

Next, the step 6 will be explained. The step 6 is to draw the glassification preform having an outer diameter of 30 mm to prepare an outer preform on the drawn glassification preform by the OVD deposition of a layer corresponding to the outer clad layer 6. The outer diameter of the outer preform was 200 mm. Then the step 7 will be explained. The step 7 is to prepare a transparent full-synthetic glass preform by transparent-glassification of the outer preform in a large scaled electric furnace having the similar performance to the electric furnace 20 for heat treatment. The heating conditions for the glassification (transparent glassification) were 1600° C., 20 l/min. of He gas supply amount to the furnace and 0.5 l/min. of Cl₂ gas supply amount. The resulting transparent full synthetic glass preform had an outer diameter of 120 mm and a length of 900 mm. Thereafter the transparent full synthetic glass preform was subjected to drawing to produce an optical fiber having an outer diameter of 125 μm and a length of 1000 km.

A cross section of the resulting optical fiber 1 will be explained by reference to FIG. 4. FIG. 4 is a photograph of a cross section along the center axis of the optical fiber 1 of the preferred embodiment. As shown in FIG. 4, the actually manufactured optical fiber 1 had a pore layer 4 having elongated pores 5 and a thickness of 10 μm around the core 2, wherein the elongated pores had an outer diameter of not larger than 1 μm

A length of sea water permeation was measured by immersing a cut portion of the optical fiber in water through the pores by the capillary action. The water permeation length of ten optical fibers was investigated. The maximum permeation length was 35 to 57 m. Then chemical properties of the optical fiber will be explained.

TABLE 1

| | | |
|---|---|---|
| Cutoff wavelength | 1470 | (nm) |
| MFD (@ 1.55 μm) | 15.3 | (μm) |
| Transmission loss | 0.172 | (dB/km) |
| Dispersion | 20.5 | (ps/km/nm) |
| Bending loss | 1.0 | (dB/m) |
| (bending radius: 20 mm) | | |

As shown in Table 1, the mode field diameter (MFD) with respect to transmission light having a wavelength of 1.55 μm that transmits through the core 2 was as large as 15.3 μm, and an effective cross section was about 170 μm², which is within a desired range. Accordingly, it is possible to reduce the non-linear effect phenomenon of the optical fiber 1. Further, the transmission loss was small so that a long distance communication is possible. In addition, the bending loss was sufficiently small from the practical point of view.

Accordingly, the optical fiber 1 exhibits improved transmission characteristics of optical signals and it is possible to reduce a cost for replacement of broken optical fiber due to permeation of sea water. The present invention provides such the optical fiber and a method of manufacturing the same.

What is claimed is:

1. An optical fiber comprising:
a core formed in a center axis area;
an inner clad layer, disposed around the core, having a refractive index smaller than that of the core;
a pore layer, disposed around the inner clad layer, having a plurality of elongated pores; and
an outer clad layer, disposed around the pore layer, having a refractive index equal to or smaller than the refractive index of the core,
wherein a length of the elongated pores is not larger than 200 m.

2. The optical fiber according to claim 1, wherein the elongated pores have a length of 10 m to 200 m.

3. The optical fiber according to claim 1, wherein the pore layer has the elongated pores of an outer diameter of 1 μm or less, in a given cross section along the center axis of the pore layer.

4. The optical fiber according to claim 2, wherein the pore layer has the elongated pores of an outer diameter of 1 μm or less, in a given cross section along the center axis of the pore layer.

5. The optical fiber according to claim 1, wherein an effective cross section of the core in a wavelength of light transmitting through the core is not smaller than 80 μm².

6. The optical fiber according to claim 1, wherein an effective cross section of the core in a wavelength of light transmitting through the core is 80 to 200 μm².

7. The optical fiber according to claim 1, wherein at least a part of the pore layer is located within a circle having a radius from the center axis, and the circle has the radius of the mode field diameter in a wavelength of light transmitting through the core.

8. The optical fiber according to claim 2, wherein at least a part of the pore layer is located within a circle having a radius from the center axis, and the circle has the radius of the mode field diameter in a wavelength of light transmitting through the core.

9. The optical fiber according to claim 3, wherein at least a part of the pore layer is located within a circle having a radius from the center axis, and the circle has the radius of the mode field diameter in a wavelength of light transmitting through the core.

10. The optical fiber according to claim 5, wherein at least a part of the pore layer is located within a circle having a radius from the center axis, and the circle has the radius of the mode field diameter in a wavelength of light transmitting through the core.

11. A method of manufacturing an optical fiber comprising:
a step for forming an inner clad layer preform around a core preform;
a step for forming a pore layer preform around the inner clad layer preform;
a step for forming an outer clad layer preform around the pore layer preform by which the core preform, the inner clad preform and the pore layer preform are unitedly molded to form an optical fiber preform; and
a step for drawing the optical fiber preform,
wherein the pore layer preform, which is similar to that of the inner clad layer is heat treated in gas atmosphere of He gas and N₂ gas to form N₂ bubbles having a diameter of 1.2 mm or less in the pore layer.

12. The method of manufacturing the optical fiber according to claim 13, wherein a mixing ratio of He gas and N₂ gas is (90 to 30%) to (10 to 70%) by volume.
